(19) United States
(12) Patent Application Publication
(10) Pub. No.: US 2010/0142459 A1
(43) Pub. Date: Jun. 10, 2010

(54) METHOD FOR SELECTING MODULATION AND CODING SCHEME

(75) Inventors: Yung Szu Tu, Jhubei City (TW); Jiunn Tsair Chen, Jhubei City (TW); Chun Hsien Wen, Jhubei City (TW); Yen Chin Liao, Jhubei City (TW)

Correspondence Address: HAMRE, SCHUMANN, MUELLER & LARSON, P.C., P.O. BOX 2902, MINNEAPOLIS, MN, 55402-0902, US

(73) Assignee: RALINK TECHNOLOGY CORPORATION, JHUBEI CITY (TW)

(21) Appl. No.: 12/499,658

(22) Filed: Jul. 8, 2009

(30) Foreign Application Priority Data
Dec. 10, 2008 (TW) 097147951

(51) Int. Cl. H04L 25/49; H04W 4/00

(52) U.S. Cl. 370/329; 375/296

(57) ABSTRACT

A method for selecting a modulation and coding scheme (MCS) applied to a multiple-antenna system. The method calculates the throughout of a plurality of MCSs based on the signal to noise ratio of the multiple-antenna system and selects a MCS from the plurality of MCSs accordingly.

### BACKGROUND OF THE INVENTION

1. Field of the Invention

The present invention relates to a method for selecting a modulation and coding scheme, and more particularly, to a method for selecting a modulation and coding scheme according to signal to noise ratio.

2. Description of the Related Art

In Wi-Fi wireless local area networks, such as those following the IEEE 802.11n standard, a receiver is required to suggest transmitter modulation and coding schemes (MCS) based on transmission environment, and the MCS adopted by the transmitter is adjusted with the variation of the transmission environment so as to maintain the highest transmission throughput.

One rate adaptation method adjusts the MCS adopted by the transmitter based on the packet error rate (PER) of the signals received by the receiver. If the PER exceeds an upper threshold, the MCS adopted by the transmitter is adjusted to another MCS with lower data rate. If the PER drops below a lower threshold, the MCS adopted by the transmitter is adjusted to another MCS with higher data rate. If the PER is between the upper threshold and the lower threshold, the MCS adopted by the transmitter remains the same. However, this rate adaptation method adjusts the MCS adopted by the transmitter from an original MCS to an adjacent one passively, but fails to find the optimum MCS according to the transmission environment.

Another rate adaptation method adjusts the MCS adopted by the transmitter based on signal to noise ratio (SNR). FIG. 1 shows experiment results of the optimum MCSs for different SNRs of the IEEE 802.11n standard. As shown in FIG. 1, the system is a double-antenna system, wherein two antennas are used for both transmission and receiving. There are 16 MCSs available, wherein number 0 to number 7 are single spatial stream MCSs, and number 8 to number 15 are double spatial stream MCSs. The receiver stores the experiment results shown in FIG. 1 in a table and adjusts the MCS adopted by the transmitter according to the stored experiment results.

However, this table requires an excessively large storage space of the receiver such that the hardware cost increases significantly. Further, if a triple antenna system or a system with more antennas is used, the required storage space would increase exponentially such that the hardware limitations could be prohibitive. Therefore, if a method for selecting a modulation and coding scheme capable of approximating the optimum MCSs were designed, not only would the transmission throughput of the transmitter increase, but the hardware cost of the receiver would also be significantly reduced.

### SUMMARY OF THE INVENTION

One objective of the present invention is the ability to determine MCS according to a mathematical formula. Use of such type of rate adaption method allows the present invention to significantly reduce the storage space required compared to conventional methods.

The method for selecting MCS for double-antenna communication system to select an MCS from available MCSs based on SNR of received signals according to one embodiment of the present invention comprises the steps of: calculating combined SNRs of single spatial stream signals emitted by the double antennas and calculating throughputs of the MCSs corresponding to the single spatial stream signals according to the combined SNR and a first equation; calculating throughputs of the MCSs corresponding to double spatial stream signals and code rate smaller than a threshold according to the SNRs of these double spatial stream signals and a second equation; calculating throughputs of the MCSs corresponding to double spatial stream signals and code rate greater than the threshold according to the SNRs of these double spatial stream signals and a third equation; and selecting an MCS from the available MCSs as the MCS for signal transmission according to these calculated throughputs.

The method for selecting MCS for multiple-antenna communication system to select an MCS from available MCSs according to SNR of received signals according to another embodiment of the present invention comprises the steps of: calculating throughputs of the MCSs with code rate smaller than a threshold according to the SNRs of multiple spatial stream signals and a first equation; calculating throughputs of the MCSs with code rate greater than a threshold according to the SNRs of multiple spatial stream signals and a second equation; and selecting an MCS from the available MCSs as the MCS for signal transmission according to these calculated throughputs.

### BRIEF DESCRIPTION OF THE DRAWINGS

The objectives and advantages of the present invention will become apparent upon reading the following description and upon referring to the accompanying drawings of which:

FIG. 1 shows experiment results of the optimum MCSs for different SNRs;

FIG. 2 shows a flow chart of a method for selecting a modulation and coding scheme according to one embodiment of the present invention;

FIG. 3 shows SNR versus packet correct rate for different MCSs for single spatial stream signals under the system of one embodiment of the present invention;

FIG. 4 shows the selected MCSs versus SNRs according to a method for selecting a modulation and coding scheme in one embodiment of the present invention; and

FIG. 5 shows a flow chart of a method for selecting a modulation and coding scheme according to another embodiment of the present invention.

### DETAILED DESCRIPTION OF THE INVENTION

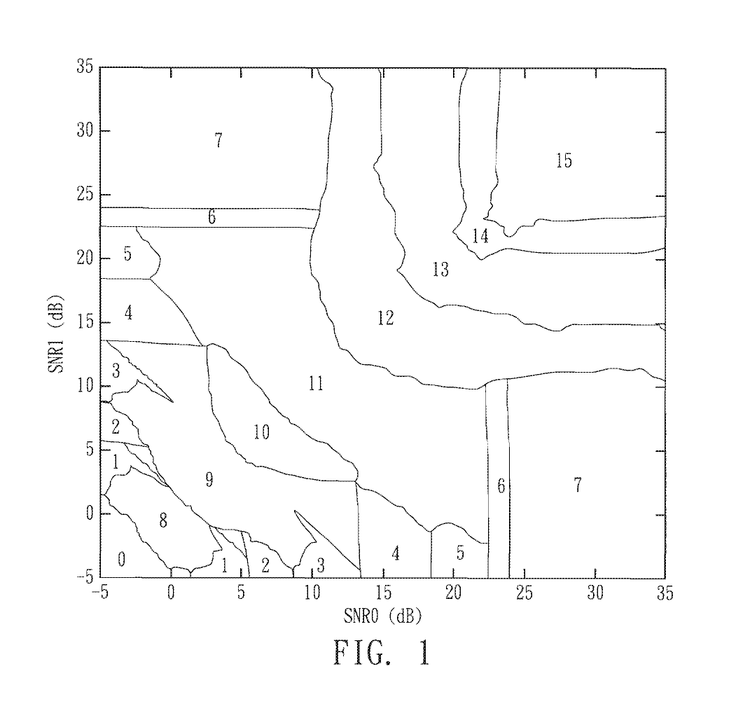

The methods for selecting a modulation and coding scheme according to embodiments of the present invention utilize mathematical equations to approximate the experiment results shown in FIG. 1 and determine MCS according to the calculation results. Referring back to FIG. 1, the boundaries for these different MCSs can be roughly categorized in three types: straight lines, oblique lines and hyperbolic curves. Accordingly, the methods according to embodiments of the present invention determine MCS based on these equations.

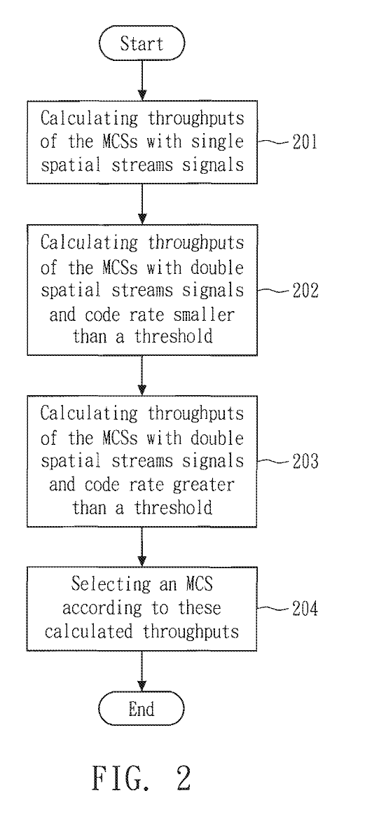

FIG. 2 shows a flow chart of a method for selecting a modulation and coding scheme according to one embodiment of the present invention, wherein the method is applied for the double-antenna system shown in FIG. 1 to select an MCS from the available MCSs according to the SNR of the received signals at the receiver. In step 201, the combined SNR of the single spatial stream signals with MCS 0-7 emitted by the double-antenna system is calculated, and the throughputs of these MCSs are also calculated according to combined SNR and a straight line equation. In step 202, the throughputs of the MCSs with the double spatial stream signals and code rate smaller than a threshold, i.e. MCS 8, 9 and 11, are calculated according to the SNRs of these double spatial stream signals and a straight-line equation. In step 203, the throughputs of the MCSs with the double spatial stream signals and code rate greater than a threshold, i.e. MCS 10 and 12-15, are calculated according to the SNRs of these double spatial stream signals and a hyperbolic curve equation. In step 204, an MCS is selected from the available MCSs as the MCS for signal transmission according to these calculated throughputs. In the present embodiment, the MCS corresponding to the highest throughput is selected.

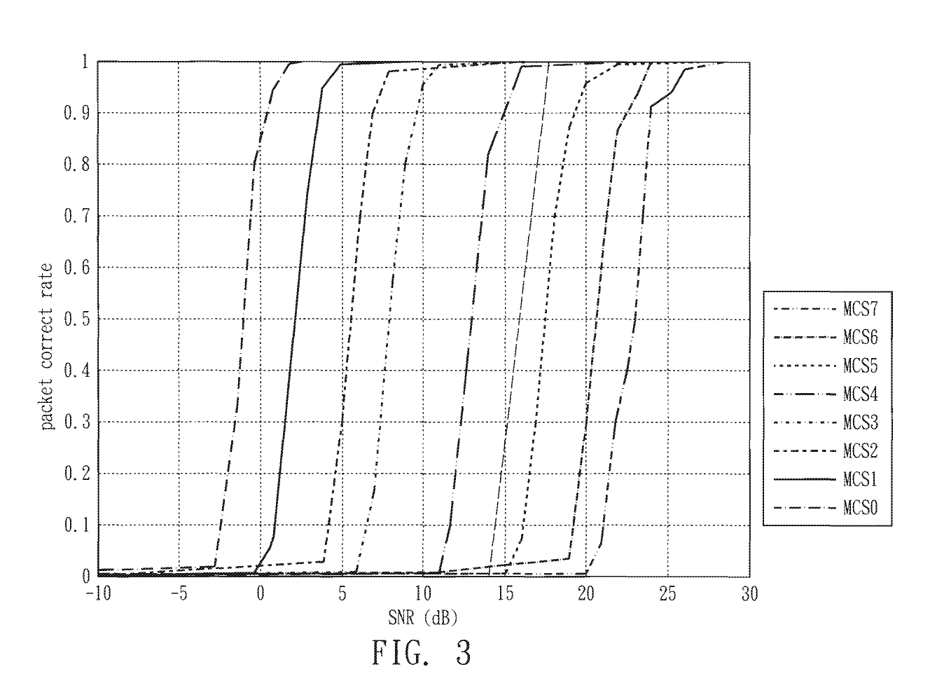

In step 201, the throughputs are calculated according to MCSs of the single spatial stream signals. Therefore, the combined SNR is calculated according to the two SNRs corresponding to these two antennas in the present embodiment. Preferably, the higher SNR of the two SNRs is selected as the combined SNR. FIG. 3 shows SNR versus packet correct rate for different MCSs for single spatial stream signals under the system of the present embodiment. The throughputs of these MCSs are calculated as the products of the data rates of these MCSs multiplied by the corresponding packet correct rate. The present embodiment approximates the relationship of SNR versus packet correct rate shown in FIG. 3 by a straight line. Therefore, the throughputs of these MCSs can be represented as follows:

data_rate(i), if SNR≧thrd(i) and S0×(SNR−thrd(i))>1;

S0×data_rate(i)×(SNR−thrd(i)), if SNR≧thrd(i) and S0×(SNR−thrd(i))≦1; and

0, if SNR<thrd(i); wherein S0 is the constant slope, data_rate(i) is the maximum data rate of the i-th MCS, i is an integer between 0 and 7 inclusive, thrd(i) is the lowest transmittable SNR of the i-th MCS and SNR is the combined SNR.

In the present embodiment, the code rates of the MCSs with boundaries of straight lines are all smaller than ½, wherein the code rates of the MCSs with boundaries of hyperbolic curves are all greater than ½. Therefore, the threshold in step 202 and 203 is ½.

In step 202, the throughputs are calculated according to MCSs of the double spatial stream signals, i.e. MCS 8, 9 and 11. As shown in FIG. 1, the packet correct rates of these MCSs are equal if the corresponding SNRs are on the same oblique line, and the probability varies with a constant slope at the boundaries shown in FIG. 1. Therefore, the throughputs of these MCSs can be represented as follows:

data_rate(i), if SNR0+SNR1≧thrd(i) and S1(SNR0+SNR1−thrd(i))>1;

S1×data_rate(i)×(SNR0+SNR1−thrd(i)), if SNR0+SNR1≧thrd(i) and S1×(SNR0+SNR1−thrd(i))≦1; and

0, if SNR0+SNR1<thrd(i), wherein S1 is the constant slope, data_rate(i) is the maximum data rate of the i-th MCS, i is an integer between 8 and 11 inclusive, thrd(i) is the lowest transmittable SNR of the i-th MCS and SNR0 and SNR1 are the SNRs of the two antennas.

In step 203, the throughputs are calculated according to MCSs of the double spatial stream signals, i.e. MCS 12-15. As shown in FIG. 1, the packet correct rates of these MCSs are equal if the corresponding SNRs are on the same hyperbolic curve, and the probability varies with a constant slope at the boundaries shown in FIG. 1. Therefore, the throughputs of these MCSs can be represented as follows:

data_rate(i), if SNR0≧thrd(i), SNR1≧thrd(i) and S2×(SNR0−thrd(i))(SNR1−thrd(i))>1;

S2×data_rate(i)×(SNR0−thrd(i))(SNR1−thrd(i)), if SNR0≧thrd(i), SNR1≧thrd(i) and S2×(SNR0−thrd(i))(SNR1−thrd(i))≦1; and

0, if SNR0<thrd(i) and SNR1<thrd(i), wherein S2 is the constant slope, data_rate(i) is the maximum data rate of the i-th MCS, i is an integer equal to 10 or between 12 and 15 inclusive, thrd(i) is the lowest transmittable SNR of the i-th MCS and SNR0 and SNR1 are the SNRs of the two antennas.

In step 204, the MCS corresponding to the highest throughput is selected from the 16 MCSs.

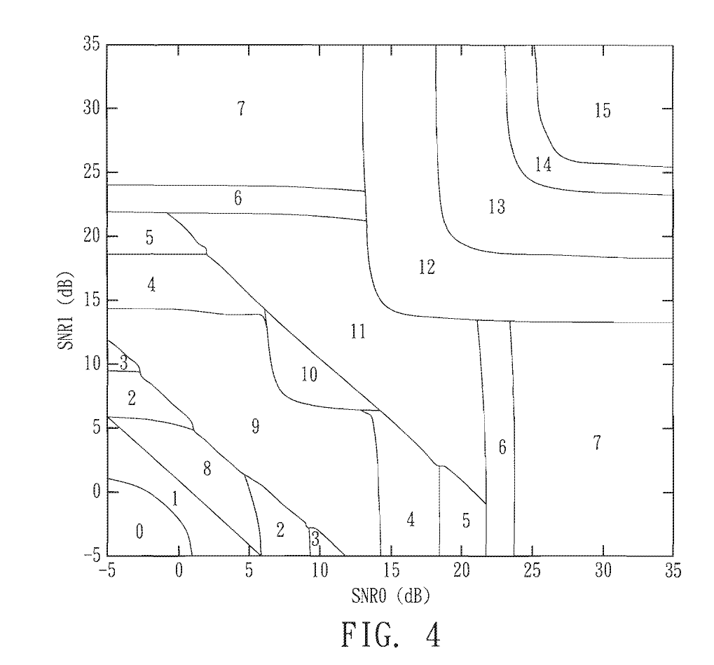

FIG. 4 shows the selected MCSs versus SNRs according to the present embodiment. It can be seen that FIG. 4 is similar to FIG. 1 and only differs slightly at the boundaries.

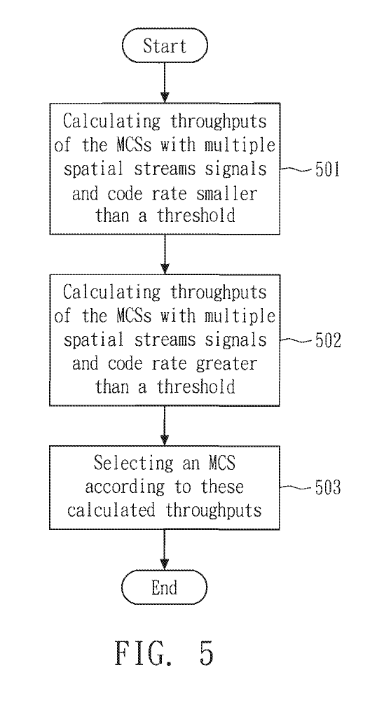

The methods for selecting a modulation and coding scheme according to embodiments of the present invention are not limited to double-antenna system, but can also be applied to multiple-antenna system. FIG. 5 shows a flow chart of a method for selecting a modulation and coding scheme according to another embodiment of the present invention. The method selects an MCS from a plurality of MCSs according to the SNR of the received signal of the multiple-antenna system. In step 501, the throughputs of the MCSs with the multiple spatial stream signals with code rate smaller than a threshold are calculated according to the SNRs of these multiple spatial stream signals and a straight line equation, wherein the threshold could be selected as ½. In step 502, the throughputs of the MCSs with multiple spatial stream signals with code rate greater than a threshold are calculated according to the SNRs of these multiple spatial stream signals and a hyperbolic curve equation. In step 503, an MCS is selected from the available MCSs as the MCS for signal transmission according to these calculated throughputs. In the present embodiment, the MCS corresponding to the highest throughput is selected.

In step 501, the throughputs of these MCSs can be represented as follows:

$$data\_rate ( i ) , if {\sum }_{j = 0}^{SS ( i ) - 1} S N R ( SS ( i ) , j ) \geq thrd ( i ) and$$

$$S ( i ) \times ( {\sum }_{j = 0}^{SS ( i ) - 1} S N R ( SS ( i ) , j ) - thrd ( i ) ) > 1 ;$$

$$S ( i ) \times data\_rate ( i ) \times ( {\sum }_{j = 0}^{SS ( i ) - 1} S N R ( SS ( i ) , j ) - thrd ( i ) ) , if$$

$${\sum }_{j = 0}^{SS ( i ) - 1} S N R ( SS ( i ) , j ) \geq thrd ( i ) and$$

$$S ( i ) \times ( {\sum }_{j = 0}^{SS ( i ) - 1} S N R ( SS ( i ) , j ) - thrd ( i ) ) \leq 1 ; and$$

0, if

$${\sum }_{j = 0}^{SS ( i ) - 1} S N R ( SS ( i ) , j ) < thrd ( i ) ;$$

wherein S(i) is the slope constant of the i-th MCS, data_rate(i) is the maximum data rate of the i-th MCS, SS(i) is the required number of spatial signals for the i-th MCS, SNR(SS(i), j) is the SNR of the j-th spatial signal among the spatial signals of the i-th MCS and thrd(i) is the lowest transmittable SNR of the i-th MCS.

In step 502, the throughputs of these MCSs can be represented as follows:

data_rate(i), if for all SS(i), all of the corresponding SNR(SS(i),j)≧thrd(i) and

$$S ( i ) \times {\prod }_{j = 0}^{SS ( i ) - 1} ( S N R ( SS ( i ) , j ) - thrd ( i ) ) > 1 ;$$

$$S ( i ) \times data\_rate ( i ) \times {\prod }_{j = 0}^{SS ( i ) - 1} ( S N R ( SS ( i ) , j ) - thrd ( i ) ) ,$$

if for all SS(i), all of the corresponding SNR(SS(i), j)≧thrd(i) and

$$S ( i ) \times {\prod }_{j = 0}^{SS ( i ) - 1} ( S N R ( SS ( i ) , j ) - thrd ( i ) ) \leq 1 ; and$$

0, if for any SS(i), there is a SNR(SS(i), j)<thrd(i), wherein S(i) is the slope constant of the i-th MCS, data_rate(i) is the maximum data rate of the i-th MCS, SS(i) is the required number of spatial signal for the i-th MCS, SNR(SS(i), j) is the SNR of the j-th spatial signal among the spatial signals of the i-th MCS and thrd(i) is the lowest transmittable SNR of the i-th MCS.

In steps 501 and 502, if SS(i) is less than the number of the total number of antennas, SNR(SS(i), j) could be selected as the j-th highest SNR of the SS(i) number of spatial signals. For example, if applied to a five antenna structure, and SS(i) is 3, then the three highest SNRs could be selected as SNR(SS(i), j). In addition, to simplify the computation, S(i) in step 501 could be set as a constant, and S(i) in step 502 could be set as another constant.

In step 503, the MCS corresponding to the highest throughput is selected from the available MCSs.

In conclusion, the methods for selecting a modulation and coding scheme according to embodiments of the present invention utilize several equations to determine the MCS for signal transmission. Compared with the conventional methods, which require a great amount of storage space, the methods according to embodiments of the present invention approximate the effect of the conventional methods by merely executing a small amount of computation.

The above-described embodiments of the present invention are intended to be illustrative only. Those skilled in the art may devise numerous alternative embodiments without departing from the scope of the following claims.

What is claimed is:

1. A method for selecting a modulation and coding scheme (MCS) applied in a double-antenna communication system, the method selecting a MCS from available MCSs according to signal to noise ratio (SNR) of received signals, comprising the steps of:
calculating combined SNRs of single spatial stream signals emitted by the double-antenna and calculating throughputs of the MCSs corresponding to the single spatial stream signals according to the combined SNR and a first equation;
calculating throughputs of the MCSs corresponding to double spatial stream signals and a code rate smaller than a threshold according to the SNRs of the double spatial stream signals and a second equation;
calculating throughputs of the MCSs corresponding to the double spatial stream signals and a code rate greater than the threshold according to the SNRs of the double spatial stream signals and a third equation; and
selecting an MCS from the available MCSs as the MCS for signal transmission according to the calculated throughputs.

2. The method of claim 1, wherein the first equation is a straight line equation.

3. The method of claim 2, wherein the throughputs of the MCSs corresponding to the single spatial stream signals are represented as follows:
data_rate(i), if SNR≧thrd(i) and S0×(SNR−thrd(i))>1;
S0×data_rate(i)×(SNR−thrd(i)), if SNR≧thrd(i) and S0×(SNR−thrd(i))≦1; and
0, if SNR<thrd(i);
wherein S0 represents a constant slope, data_rate(i) is a maximum data rate of an i-th MCS, thrd(i) is the lowest transmittable SNR of the i-th MCS and SNR is the combined SNR.

4. The method of claim 1, wherein the second equation is a straight line equation.

5. The method of claim 4, wherein the throughputs of the MCSs corresponding to the double spatial stream signals and the code rate smaller than the threshold are represented as follows:
data_rate(i), if SNR0+SNR1≧thrd(i) and S1(SNR0+SNR1−thrd(i))>1;
S1×data_rate(i)×(SNR0+SNR1−thrd(i)), if SNR0+SNR1≧thrd(i) and S1×(SNR0+SNR1−thrd(i))≦1; and
0, if SNR0+SNR1<thrd(i);
wherein S1 represents the constant slope, data_rate(i) is the maximum data rate of the i-th MCS, thrd(i) is the lowest transmittable SNR of the i-th MCS, and SNR0 and SNR1 are the SNRs of the double antennas.

6. The method of claim 1, wherein the third equation is a hyperbolic curve equation.

7. The method of claim 6, wherein the throughputs of the MCSs corresponding to the double spatial stream signals and the code rate greater than the threshold are represented as follows:
data_rate(i), if SNR0≧thrd(i), SNR1≧thrd(i) and S2×(SNR0−thrd(i))(SNR1−thrd(i))>1;
S2×data_rate(i)×(SNR0−thrd(i))(SNR1−thrd(i)), if SNR0≧thrd(i), SNR1≧thrd(i) and S2×(SNR0−thrd(i))(SNR1−thrd(i))≦1; and
0, if SNR0<thrd(i) and SNR1<thrd (i);
wherein S2 represents the constant slope, data_rate(i) is the maximum data rate of the i-th MCS, thrd(i) is the lowest transmittable SNR of the i-th MCS, and SNR0 and SNR1 are the SNRs of the double antennas.

8. The method of claim 1, wherein the threshold is ½.

9. The method of claim 1, wherein the combined SNR is the higher SNR of two SNRs corresponding to the double antennas.

10. The method of claim 1, wherein the selected MCS corresponds to a highest throughput.

11. The method of claim 1, which is applied to the IEEE 802.11n system standard.

12. A method for selecting a modulation and coding scheme (MCS) applied in a multiple-antenna communication system, the method selecting an MCS from available MCSs according to signal to noise ratio (SNR) of received signals, comprising the steps of:
calculating throughputs of MCSs with a code rate smaller than a threshold according to SNRs of multiple spatial stream signals and a first equation;
calculating throughputs of MCSs with a code rate greater than a threshold according to the SNRs of multiple spatial stream signals and a second equation; and
selecting an MCS from available MCSs as the MCS for signal transmission according to the calculated throughputs.

13. The method of claim 12, wherein the first equation is a straight line equation.

14. The method of claim 13, wherein the throughputs of the MCSs with the code rate smaller than the threshold are represented as follows:
$$data\_rate ( i ) , if$$
$${\sum }_{j = 0}^{SS ( i ) - 1} S N R ( SS ( i ) , j ) \geq thrd ( i ) and$$
$$S ( i ) \times ( {\sum }_{j = 0}^{SS ( i ) - 1} S N R ( SS ( i ) , j ) - thrd ( i ) ) , if$$
$${\sum }_{j = 0}^{SS ( i ) - 1} S N R ( SS ( i ) , j ) \geq thrd ( i ) and$$
$$S ( i ) \times ( {\sum }_{j = 0}^{SS ( i ) - 1} S N R ( SS ( i ) , j ) - thrd ( i ) ) \leq 1 ; and$$
$$0 , if {\sum }_{j = 0}^{SS ( i ) - 1} S N R ( SS ( i ) , j ) < thrd ( i ) ;$$
wherein S(i) represents a slope constant of an i-th MCS, data_rate(i) is a maximum data rate of the i-th MCS, SS(i) represents a required number of spatial signals for the i-th MCS, SNR(SS(i), j) is the SNR of the j-th spatial signal among the spatial signals of the i-th MCS, and thrd(i) is the lowest transmittable SNR of the i-th MCS.

15. The method of claim 14, wherein if SS(i) is smaller than the total number of the multiple antennas, SNR(SS(i), j) is selected as a j-th highest SNR of SS(i) number of spatial signals.

16. The method of claim 14, wherein S(i) is a same constant for all MCSs.

17. The method of claim 12, wherein the second equation is a hyperbolic curve equation.

18. The method of claim 17, wherein the throughputs of the MCSs with the code rate greater than the threshold are represented as follows:
data_rate(i), if for all SS(i), all of the corresponding SNR(SS(i), j)≧thrd(i) and
$$S ( i ) \times {\prod }_{j = 0}^{SS ( i ) - 1} ( S N R ( SS ( i ) , j ) - thrd ( i ) ) > 1 ;$$
$$S ( i ) \times data\_rate ( i ) \times {\prod }_{j = 0}^{SS ( i ) - 1} ( S N R ( SS ( i ) , j ) - thrd ( i ) ) ,$$
if for all SS(i), all of the corresponding SNR(SS(i), j)≧thrd(i) and
$$S ( i ) \times {\prod }_{j = 0}^{SS ( i ) - 1} ( S N R ( SS ( i ) , j ) - thrd ( i ) ) \leq 1 ; and$$
0, if for any SS(i), there is a SNR(SS(i), j)<thrd(i);
wherein S(i) is the slope constant of the i-th MCS, data_rate(i) is the maximum data rate of the i-th MCS, SS(i) is the required number of spatial signals for the i-th MCS, SNR(SS(i), j) is the SNR of the j-th spatial signal among the spatial signals of the i-th MCS, and thrd(i) is a lowest transmittable SNR of the i-th MCS.

19. The method of claim 17, wherein if SS(i) is smaller than the total number of the multiple antennas, SNR(SS(i), j) is selected as the j-th highest SNR of a SS(i) number of spatial signals.

20. The method of claim 17, wherein S(i) is a same constant for all MCSs.

21. The method of claim 12, wherein the threshold is ½.

22. The method of claim 12, wherein the selected MCS corresponds to a highest throughput.

23. The method of claim 12, which is applied to the IEEE 802.11n system standard.
